(19) United States
(12) Patent Application Publication
(10) Pub. No.: US 2006/0032537 A1
(43) Pub. Date: Feb. 16, 2006

(54) Electronic monitoring unit

(76) Inventor: Tomas Kalble, Hannover (DE)

Correspondence Address: JACKIE JAY SCHWARTZ, 1350 Broadway, Suite 1510, NEW YORK, NY, 10018, US

(21) Appl. No.: 11/200,887

(22) Filed: Aug. 10, 2005

(30) Foreign Application Priority Data
Aug. 12, 2004 (DE) 10 2004 039 138.6

(51) Int. Cl. F16K 37/00

(52) U.S. Cl. 137/557

(57) ABSTRACT

The invention relates to an electronic monitoring unit (1) for a valve unit (2), including a plurality of valves (4) arranged side by side on a valve carrier body (3), having at least one electrically operable valve drive (6), said valve unit (2) comprising at least one feeding channel (7) and one vent channel (8), and each valve (4) having at least one working channel (5) associated with it.

According to the invention it is provided that a plurality of monitoring channels (9) extend within said monitoring unit (1) each associated with one working channel (5) of a valve (4), said monitoring channels (9) each being connectable with the associated working channel (5) and each comprising a sensor unit (10) to detect the pressure within the working channel (5).

### FIELD OF THE INVENTION

The present invention relates to an electronic monitoring unit for a valve unit comprising a plurality of valves arranged side by side at a valve carrier body and having at least one electrically operable valve drive, wherein the valve unit has at least one feeding channel and one venting channel, and each valve has at least one working channel associated with it.

### BACKGROUND OF THE INVENTION

It is generally known that valve units of the type mentioned above can be monitored by various means. The field of use of these valve units is for example in the paper and print industries or in the automotive industry. It is particularly important to monitor the switching states during operation in order to detect any failure of one or more valves at an early point in time. In some of the fields of use it is particularly important to have only one valve in operation at anyone time. This means that only one working channel of one valve has the relevant working pressure applied to it, while no working pressure is applied to any of the remaining working channels of the neighboring valves. It is known, for example, that there are for this purpose mechanical devices which prevent the simultaneous driving of more than one valve. It is not possible to simultaneously apply the working pressure to a plurality of valves, since the primary driven valve always switches off the supply pressure for the subsequent valves. One of the drawbacks is that this apparatus needs a large structural volume. So-called software latches are also known for monitoring a valve unit, which determine whether two valves are electrically driven at the same time. One of the drawbacks is, however, that only the electrical circuit is monitored which supplies current to each valve. If, for example, the valve has a mechanical fault, this is not detected by the software. This means that internal valve defects cannot be detected resulting in the pneumatic load being erroneously driven.

In DE 44 03 156 A 1, an apparatus for driving a magnetic switching valve is described wherein a microprocessor exclusively monitors the. driving circuit, but not the actual actuator. The actuator is thus not included in the monitoring circuit so that its integrity cannot be monitored in operation.

DE 34 35 465 A 1 describes a method and apparatus for monitoring the operability of a dedicated actuator for the injection control circuit of a motor vehicle, wherein the auto-diagnosis is carried out, however, only in certain operational states, so that monitoring in the running operation is not possible.

### SUMMARY OF THE PRESENT INVENTION

It is an object of the present invention to avoid the above mentioned drawbacks, in particular, to provide a monitoring unit for a valve unit which is simple and cheap to manufacture. At the same time permanent monitoring can be carried out while in operation. Moreover, the monitoring unit. should be easy to arrange on the valve unit to be monitored without much mounting overhead.

An electronic monitoring unit having the features of claim 1 is suggested to achieve the present object. Preferred embodiments are defined in the dependent claims.

It is provided according to the present invention that a plurality of monitoring channels, each associated with one working channel, extend within the monitoring unit, which can be connected with the associated working channel and each comprise one sensor unit to detect the pressure within the working channel. The monitoring unit according to the present invention is configured thus that it can be coupled to the valve unit with little mounting overhead. The monitoring channels are connected with the associated working channels of the individual valves, wherein the sensor unit arranged in each monitoring channel can detect the pressure present in each working channel. With such an arrangement a reliable checking of the individual neighboring valves can be achieved, for example, as to whether one or a plurality of valves are driven. If a certain valve is driven, it has a certain working pressure within the working channel, which is detected by the sensor unit in each monitoring channel. The monitoring unit which can be arranged at the valve unit determines, for example, whether one or more valves have operating faults. Unlike the prior art apparatus, the monitoring unit according to the present invention checks the integrity of the hardware (of each individual valve). The monitoring unit can, for example, be flanged to the valve unit, wherein a corresponding monitoring channel is associated with each working channel of a valve. The monitoring channels and the working channels can be in immediate communication, for example. In another embodiment, an indirect communication, such as via a flexible hose, is also possible. It is particularly advantageous that monitoring within the individual valves of the valve unit can be permanently carried out during operation by diagnosing the working pressures within the working channels.

The monitoring unit suitably has a carrier body which is integrally formed with the monitoring channels. The monitoring unit can be of metal, in particular aluminum, which is integral with the monitoring channels. For example, such monitoring channels can be machined, in particular milled, in the carrier body. According to another embodiment of the present invention, the carrier body can also be made of plastic. In another embodiment of the present invention, the carrier body can also be an injection molded plastic part.

Preferably, the sensor unit arranged in the monitoring channel is configured as a pneumatic-electronic pressure transducer. The sensor unit can then be a piezo-resistive pressure sensor. Each sensor unit is arranged within each monitoring channel in nsuch a way that it can reliably detect the pressure present therein. The individual sensor units are preferably connected in parallel with the processor unit. In operation, each sensor unit receives a certain pressure signal within the monitoring channel, which is then transformed into an analog signal. In a further step, said analog signal is passed on to a processor unit.

Said processor unit is preferably integrated in the monitoring unit which evaluates all received pressure signals. The evaluation or checking whether one or more valves are driven or operated simultaneously at anyone time, can be done, for example, in such a way that the detected analog pressure signal (actual value) is compared with a setpoint value stored in the sensor unit. An error message can be output, for example, by the processor unit, if the actual value differs from the setpoint value. In another embodiment of the present invention, the setpoint value can also be used as threshold value. If the actual value (actual pressure in the working channel) is below the threshold value, this indicates to the processor unit that the valve in question is not being driven. Suitably, the threshold values are capable of being parameterized. It is, of course, also possible to provide a different threshold value for each working channel within the valve unit.

In the monitoring unit according to the present invention, the threshold value may remain fixed in operation. In another alternative, it may be necessary in some applications for the threshold value to be variable in operation, which is also contemplated in the present invention.

The processor unit coupled to a memory can be integrated in a microcontroller. The memory is preferably a silicon chip, with a very small weight and very small dimensions, requiring a very small amount of current. The connection between the processor unit and the control unit, can be achieved, for example, by electrical or wireless means which, in one embodiment, is a radio link. The radio link is preferably in the GHz range, according to the Bluetooth standard as specified by the Blue Tooth Special Interest Group. If the processor unit detects a fault function of one of the valve units, in that the pressure measured in one of the working channels does not correspond to the pressure value stored in the sensor unit, the processor unit, in a possible alternative of the present invention, sends an error signal to the control unit, which then ceases to drive the valve unit, for example.

In another alternative, a blocking valve can be brought into signaling communication with the monitoring unit, which closes the feeding channel when a monitoring unit sends an error message. In this possible embodiment, the processor unit sends the error signal to the blocking valve, which then closes off the feeding pressure of the valve unit.

The valve can be a five-way, two-position directional control valve or a five-way, three-position directional control valve or a two-times three-way, two-position directional control valve. The monitoring channel can have a first connecting section which can be attached to the working channel. The monitoring channel suitably also has a second connecting section opposite the first connecting section, which can be connected to a pneumatic load. The second connecting sections can be configured, for example, as “push-ins”, for example of plastic material. The first connecting section may suitably be inserted into each associated working channel of each valve ensuring a reliable connection of the working channel with each monitoring channel.

Alternative positive or non-positive connections between the working channel and the monitoring channel are also possible. The monitoring unit according to the present invention is thus a compact apparatus which can be fixed on a valve unit, whereby a permanent checking of the working pressure (output signal) of each valve is carried out. The monitoring cycles are preferably in the order of 1 ms. Depending on the requirements, the monitoring cycles can, of course, be changed. The monitoring unit according to the present invention is thus suitable for checking the output signal of each valve during operation, in particular to check whether a certain setpoint pressure is really present in a working channel of a valve.

Further advantages, features and details of the present invention can be derived from the following description, in which embodiments of the present invention will be described in detail with reference to the accompanying drawings. The features mentioned in the claims and in the description may by critical for the invention individually orin combination.

### BRIEF DESCRIPTION OF THE SEVERAL VIEWS OF THE DRAWINGS

FIG. 1 shows a valve unit with a plurality of valves arranged side by side on a valve carrier body;

FIG. 2 shows an electronic monitoring unit according to the present invention which can be mounted on the valve assembly of FIG. 1;

FIG. 3 is a side view of the electronic monitoring unit according to FIG. 2;

FIG. 4 is a plan view of the valve unit according to FIG. 1;

FIG. 5 is a plan view of the electronic monitoring unit according to FIG. 2; and

FIG. 6 shows an alternative embodiment of the monitoring unit according to FIG. 3, in a side view.

### DETAILED DESCRIPTION OF THE INVENTION

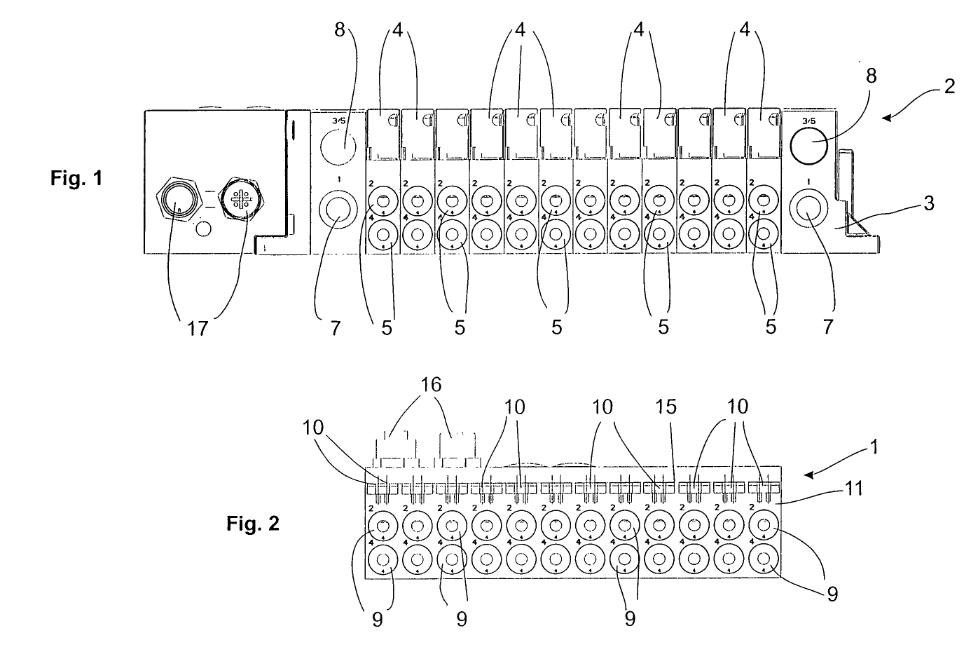

FIG. 1 shows a valve unit 2 comprising a plurality of valves 4 arranged on a valve carrier body 3. The valve carrier body 3 defines the length of the valve unit 2. With the present valve unit 2, the valve carrier body 3 is an integral part and can be, in particular, an extruded body of aluminum material. Compared with injection molded plastic, the extrusion method has the advantage that exceedingly variable dimensions are achievable. In particular, It is possible to manufacture the valve carrier body 3 on the basis of goods sold by meters, which are cut to size according to the desired structural length of the valve carrier body 3. Eliminating complex mounting procedures of individual components, this ensures that exceedingly variable structural lengths may be obtained.

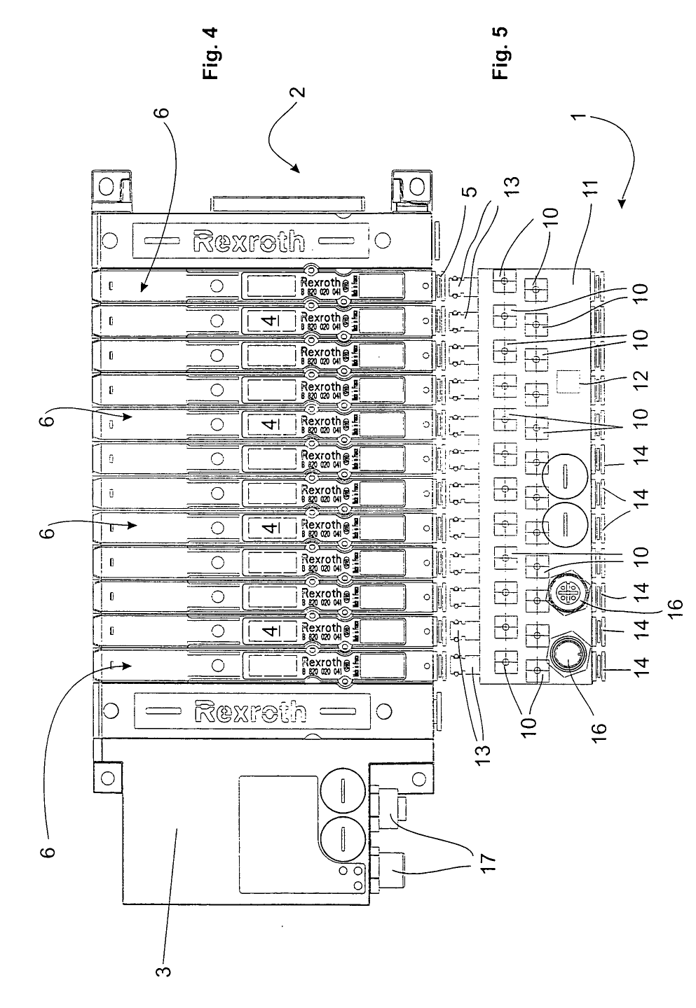

As also shown in FIG. 4, a plurality of valves 4 are arranged on the valve carrier body 3 in a side-by-side relationship. Each valve 4 is provided with at least one electrically operable valve drive 6 (not shown). While it is basically immaterial which types of valves are used, in the present exemplary embodiment a two-times three-way, two-position directional control valve, each equipped with a single valve drive 6 is used.

As valve drives 6 electromagnets or preferably piezo-actuators are used, for example. Depending on their type, they can either directly actuate the valve 4 or can operate on a pilot valve used to pilot control the valve 4.

The valves 4 can be arranged on the valve carrier body 3 in a positive and/or non-positive and/or metallurgical manner. In a preferred embodiment, the valves 4 are fixed on the valve carrier body 3 by means of screws. Other ways of fastening are also conceivable, such as locks and/or snap-locks.

As can be seen from FIG. 1 and FIG. 4, the valve unit 2 has two feeding channels 7 and two vent channels 8. These channels 7,8 extend in the interior of the valve unit 2 and communicate with each valve 4. A pressure line (not shown) can be connected to each feeding channel 7 to feed a pressurized medium from a pressure source into the feeding channel 7. The used pressurized medium can escape through the vent channels 8. The vent channel 8 need not necessarily be connected to a pressure line. In this context it would also be possible to connect a muffler, for example.

Each valve 4 has two working channels 5 in the embodiment shown, each capable of being connected to a pneumatic load, such as a fluid operated drive. Depending on the switching position caused by the valve drive 6 of each valve 4, it is capable of connecting the individually associated working channel optionally with the feeding channel 7 or the vent channel 8, each of the other channels being cut off.

According to FIG. 1 and FIG. 4, the valve unit 2 has terminals 17 enabling the individual valves 4 to be electrically driven. The terminals 17 can also be used to effect a data transfer. A control unit (not shown) is connected to the individual valves 4 via the terminals 17.

In order to ensure reliable monitoring of the individual valves 4 of the valve unit 2, an electronic monitoring unit 1 is used as shown in FIG. 2 and FIG. 5. A plurality of monitoring channels 9 extend within the monitoring unit 1, each associated with a single working channel 5 of a valve 4, the monitoring channels 9 being capable of being connected with the associated working channel 5 and each comprising a sensor unit 10 to detect the pressure within the working channel 5. The monitoring unit 1 can be releasably attached to the valve unit 2 without much mounting overhead, by inserting each monitoring channel 9 into each associated working channel 5.

The monitoring unit 1, in the exemplary embodiment of the present invention shown, is illustrated in a state not inserted in the valve unit 2. As illustrated, in particular, by FIG. 4 and FIG. 5, each monitoring channel 9 has a first connecting section 13 protruding from the monitoring unit 1. The first connecting sections 13 are at a certain distance from the neighboring connecting sections 13, each arranged side by side and below each other. The positions of the individual monitoring channels 9 are adapted to the arrangement of the working channels 5 of the valve unit 2. Corresponding to the exemplary embodiment shown, the valve unit 2 has 24 working channels 5 so that, correspondingly, the monitoring unit has 24 monitoring channels 9. The cross-section of the working channels 5 and of the monitoring channels 9is circular in the exemplary embodiment shown. Other geometric forms are, or course, also possible. The monitoring unit 1 has a carrier body 11, through which the monitoring channels 9 extend. The monitoring channels 9 can be machined, for example, by milling in the carrier body 11, of aluminum in the exemplary embodiment shown. Each monitoring channel 9 has a sensor unit 10 associated with it which is suitable to measure the pressure applied within each monitoring channel 9. To bring the sensor units 10 in reliable contact with the monitoring channels 9, the monitoring channels 9 can be staggered with respect to each other within the carrier body 11, which is not shown. The sensor unit 10 configured as a piezo-resistive pressure sensor is mounted in a printed circuit board 15, wherein the individual piezo-resistive pressure sensors 10 are electrically connected in parallel. The sensor units 10 are connected to a processor unit 12 arranged within the monitoring unit 1, as shown in FIG. 5. The processor unit 12 can be connected, in turn, to a control unit (not shown).

The monitoring unit 1 also has two terminals 1.6 for signal output. If the electric monitoring unit 1 is mounted on the valve unit 2, the pressure of each working channel 5 can be monitored during operation on a permanent basis. To do this, the piezo-resistive pressure sensor 10 measures the pressure within each monitoring channel 9 which is then converted to an analog signal and sent to the processor unit 12. The processor unit 12 evaluates the pressure (actual value) measured for each individual working channel by comparing the actual value with a setpoint value. If the processor unit 12 cannot determine a match between the actual value and the setpoint value or if the measured actual value is outside a previously determined tolerance range with respect to the setpoint value, the processor unit 12 issues an error signal. The error signal can be sent, for example, to the control unit via the electric terminals 16. Due to the error occurring, the control unit can switch off, for example, the drive of the valve unit 2. It is also possible for a blocking valve (not shown) in signal communication with the monitoring unit 1 to close off the feeding channels 7. Preferably, the electronic monitoring unit 1 is also capable of passing on a signal via the electric terminals 16, indicating which of the valves 4 monitored is faulty. This can be made visible to a user using, for example, a display unit, wherein the user can then quickly replace or repair the defective valve 4.

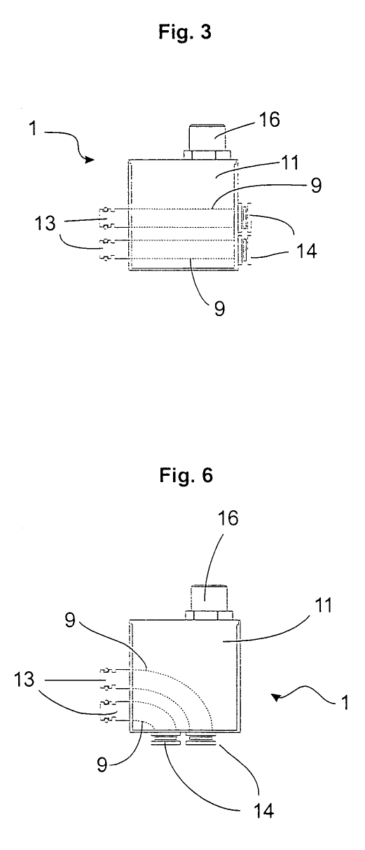

FIG. 3 illustrates a side view of the monitoring unit 1. On the side opposite the first connecting section 13, there is a second connecting section 14 which can be connected to a pneumatic load. Herein, the monitoring channels 9 extending from the first to the second connecting section 13, 14 in a straight line, the form of the channels 9 being shown here as a broken line. In another embodiment of the present invention, the monitoring channels 9 can be in a staggered configuration within the carrier body 11, facilitating a connection of the individual sensor units 10 on each monitoring channel 9.

FIG. 6 shows another embodiment of the monitoring unit 1 basically identical in structure to the monitoring unit 1 of FIG. 2 or FIG. 5. The only difference is that the second connecting section 14 is offset from the associated first connecting section 13 on the carrier body 11 by 90°. For this reason, each monitoring channel 9 has a curvilinear path.

A simple apparatus is created by the monitoring unit 1 of the present invention able to monitor the working pressure in each working channel 5 by arranging the monitoring unit 1 between the valve unit 2 and a pneumatic load. The monitoring unit 1 is releasably attached to the valve unit 2 and is immediately adjacent to the valve unit wall so that a compact unit is created that does not need much structural space. Of course, it is always possible to position an intermediate section (such as a flexible tube) between each working channel 5 and the associated monitoring channel 9 or the associated first connecting section 13 of the working channel 9, which may be necessary with certain structural requirements.

1. An electronic monitoring unit (1) for a valve unit (2), including a plurality of valves (4) arranged side by side on a valve carrier body (3), having at least one electrically operable valve drive (6), said valve unit (2) comprising at least one feeding channel (7) and one vent channel (8), and each valve (4) having at least one working channel (5) associated with it, wherein a plurality of monitoring channels (9) extend within said monitoring unit (1) each associated with one working channel (5) of a valve (4), said monitoring channels (9) each being connectable with the associated working channel (5) and each comprising a sensor unit (10) to detect the pressure within the working channel (5).

2. The electronic monitoring unit (1) according to claim 1, wherein said monitoring unit (1) has a carrier body (11) which is integrally formed with the monitoring channels (9).

3. The electronic monitoring unit (1) according to claim 1, wherein said sensor unit (10) is configured as a pneumatic-electronic pressure transducer.

4. The electronic monitoring unit (1) according to claim 3, wherein said sensor unit (10) is a piezo-resistive pressure sensor.

5. The electronic monitoring unit (1) according to claim 1, wherein said sensor unit (10) is connected to a processor unit (12) arranged within said monitoring unit (1).

6. The electronic monitoring unit (1) according to claim 5, wherein said processor unit (12) is connectable with a control unit.

7. The electronic monitoring unit (1) according to claim 6, wherein said processor unit (12) is connectable with said control unit by wireless means.

8. The electronic monitoring unit (1) according to claim 7, wherein said wireless connection is a radio link.

9. The electronic monitoring unit (1) according to claim 1, wherein a blocking valve can be brought into signal communication with the monitoring unit (1) to close off the feeding channel (7) in response to an error message from the monitoring unit (1).

10. The electronic monitoring unit (1) according to claim 1, wherein said monitoring channels (9) extend side by side and spaced from each other.

11. The electronic monitoring unit (1) according to claim 1, wherein said carrier body (11) is of metal.

12. The electronic monitoring unit (1) according to claim 1, wherein said valve (4) is a five-way, two-position directional control valve or a five-way, three-position directional control valve or a two times three-way, two-position directional control valve.

13. The electronic monitoring unit (1) according to claim 1, wherein said monitoring channel (9) has a first connecting section (13) capable of being attached at the working channel (5).

14. The electronic monitoring unit (1) according to claim 13, wherein monitoring channel (9) comprises a second connecting section (14) opposite the first connecting section (13) and capable of being connected to a pneumatic load.

15. The electronic monitoring unit (1) according to claim 13, wherein said first connecting section (13) is of metal and said second connecting section (14) is of plastic or metal.

16. The electronic monitoring unit (1) according to claim 1, wherein said carrier body (11) comprises a printed circuit board (15) on which said sensor units (10) are mounted.

17. The electronic monitoring unit (1) according to claim 1, wherein said processor unit (12) evaluates signals of the sensor unit (10) and provides the signals for further processing.
